(19) United States
(12) Patent Application Publication
(10) Pub. No.: US 2007/0185904 A1
(43) Pub. Date: Aug. 9, 2007

(54) Graphics image generation and data analysis

(75) Inventors: Hirofumi Matsuzawa, Sagamihara-shi (JP); Tohru Nagano, Yokohama-shi (JP); Takayuki Itoh, Yokohama-shi (JP); Yumi Yamaguchi, Yamato-shi (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/933,657

(22) Filed: Sep. 2, 2004

(30) Foreign Application Priority Data
Sep. 10, 2003 (JP) 2003-318890

(51) Int. Cl. G06F 7/00

(52) U.S. Cl. 707/104.1

(57) ABSTRACT

Provides graphics display apparatus, systems and methods for effectively presenting information obtained by data mining, and to improve the visibility of the display of individual data elements and attributes of data included in a particular category while allowing an overview of whole large-scale hierarchical data to be provided. An example embodiment includes an aggregation unit for performing aggregation of attributes of nodes in the hierarchical data according to given aggregation criteria; a filtering unit for filtering the result of aggregation performed by the aggregation unit according to given filtering criteria to select nodes to be displayed from the hierarchical data; and a visualization unit for generating a graphics image that includes the nodes to be displayed selected by the filtering unit and reflects the hierarchical structure of the hierarchical data.

### FIELD OF THE INVENTION

The present invention relates to a graphics display technique for generating a graphics image of hierarchical data.

### BACKGROUND ART

With the widespread use of computer-based database system, various approaches to data mining systems for extracting desired information from vast amounts of data have been proposed.

The following documents are considered:

[Non-Patent Document 1]
Hirofumi Matsuzawa, Toru Nagano, Akiko Murakami, Hironobu Takeuchi, Koichi Takeda, and Yasushi Kanda, “MedTAKMI: A text mining system for databases of bio-medical document,” Workshop on data mining, Japan Society for Software Science and Technology, September 2000

[Non-Patent Document 2]
Hao M. C., Hsu M., DayalU., and Krug A., “Web-based Visualization of Large Hierarchical Graphs Using Invisible Links in a Hyperbolic Space,” HP Laboratories Palo Alto, HPL-2000-2

[Non-Patent Document 3]
Ben Shneiderman, “Treemaps for space-constrained visualization of hierarchies,” May 21, 2003 (retrieved on Jun. 19, 2003), <URL: http://www.cs.umd.edu/hcil/treemap-history/index.shtml>

[Non-Patent Document 4]
Ito, Kajinaga, and Ikehata, “Data jewel-box: a graphics showcase for large-scale hierarchical data visualization,” Special Interest Group on Graphics and CAD, Information Processing Society of Japan, 2001-CG-104, 2001

[Non-Patent Document 5]
Yamaguchi and Ito, “Data jewel-box II: a graphics showcase for large-scale hierarchical data visualization using positional information template,” Special Interest Group on Graphics and CAD, Information Processing Society of Japan, 2002-CG-108, 2002

For example, some text mining systems for document files such as research paper files have the capability of finding insights contained in a large number of documents by using category information, words, and modification relations between words in the documents (see non-patent document 1, for example).

For example, the United States National Library of Medicine stores 11,000,000 biomedical research papers (as of September 2002). The library defines a category system called MeSHTerm and a label is assigned to each paper to indicate which category the paper belongs to. The labels can be used for searches. More than one category is assigned to one document. This category system has a huge hierarchical structure including as many as 38,000 nodes in total (as of September 2002).

A text mining system called IBM TAKMI for biomedical documents (abbreviated to MedTAKMI system) described in non-patent document 1 provides an analysis function for such hierarchical structures. In this system, by specifying one node (category) in a tree-structured category system, all the documents in the category system, including documents in all descendant node categories of that node can be aggregated and analyzed.

Various other technologies have been proposed that display such a data constellation (hereinafter referred to as hierarchical data) in graphical form in which a number of data elements are organized into a hierarchical structure (see non-patent documents 2 to 5, for example).

A prior-art approach using a Hyperbolic Tree method disclosed in non-patent document 2 arranges a tree structure in a hyperbolic space to represent both a hierarchical structure of data and a link structure among date elements.

Another prior-art approach using Treemap method disclosed in non-patent document 3 splits a screen space on which hierarchical data is to be displayed into regions in alternating horizontal and vertical directions and associates each of the regions with each data element, thereby representing a hierarchical structure of the data.

In prior-art graphics display technologies disclosed in non-patent documents 4 and 5, icons of data at the lowest level are enclosed in a graphic such as a rectangle, then a graphic enclosing a cluster of such graphics is created to represent a higher level, another graphic enclosing the graphics at the higher level is created, and this process is repeated until the highest level is reached to arrange data in the screen space.

As described above, data mining systems have the capability of analyzing vast amounts of data to obtain insights contained in the data. However, if the size of a database analyzed is large, a difficulty arises in how information obtained should be presented to a user.

For example, most researchers (analysts) who analyze the research paper database in the United States National Library of Medicine by performing text mining by means of the text mining system IBM TAKMI for biomedical documents described know categories to research because the category system defined by the library is in the public domain. Most analysts analyze only the categories familiar to them because it is difficult for them to search the database to find nodes that contain insights of interest from among as many as 40,000 nodes or to investigate all nodes by following related nodes.

From the viewpoint of data mining, however, it is desirable that, if any other categories include noteworthy insights, the insights should be presented to researchers. For example, if an analyst searches first a category familiar to him or her for information that relates to a number of categories, he or she may not notice the other categories that relates to the information. To avoid this, it is desirable to provide a function that indicates to a user with which node in a category system of a database the user should start analysis and provides the user with an overview of the whole category system of the database.

The graphics display technologies described above can provide an at-a-glance output in which a user can see data elements of a hierarchical structure. However, the output is not always easy to look at if it displays all of thousands of tens of thousands data elements directly.

The prior art disclosed in non-patent document 2 that uses the Hyperbolic Tree method locates lowest-level data elements at the edge of a radial tree structure. Therefore, it is difficult to display thousands or tens of thousands data elements.

The prior art disclosed in non-patent document 3 that uses the Treemap method provides a graphics display method suitable for relatively large scale hierarchical data. However, when thousands or tens of thousands data elements were displayed, a unit display area mapped to each data element would be so small that the visibility decreases.

The prior art disclosed in non-patent documents 4 and 5 provides the capability of displaying a bar graph representing the attributes of data on a graphic associated with each data element. With this capability, when a piece of information that relates to a number of categories is used as search criteria, bars associated with particular data elements in the categories project from the graphics around that information. Thus, the relation between the information used as the search criteria and the data elements can readily be known. However, if bars are displayed for thousands or tens of thousands data elements, the image is crowded with the bars, degrading the visibility.

### SUMMARY OF THE INVENTION

In light of these problems, an aspect of the present invention is to provide a graphics display system and method for effectively presenting information obtained by data mining.

Another aspect of the present invention is to improve the visibility of the display of each individual data element and attributes of data included in a particular category while allowing an overview of whole large-scale hierarchical data to be provided.

The present invention achieves these aspects implemented as a graphics image generation apparatus which visualizes a hierarchical structure of hierarchical data and presenting the visualized data and is configured as follows. The graphics image generation apparatus includes an aggregation unit for performing aggregation of attributes of nodes in the hierarchical data according to given aggregation criteria; a filtering unit for filtering the result of aggregation performed by the aggregation unit according to given filtering criteria to select nodes to be displayed from the hierarchical data; and a visualization unit for generating a graphics image that includes the nodes selected by the filtering unit and reflects the hierarchical structure of the hierarchical data. More specifically, the aggregation unit obtains an aggregate value for a given node in the hierarchical data, the aggregate value being the result of aggregation of an attribute of the given node, and obtains a summarized aggregate value by summarizing aggregate values for descendant nodes of the given node into the aggregate value of the given node. The filtering unit replaces an aggregate value of a node that is determined as being ineligible to be displayed according to the given filtering criteria with the summarized aggregate value and determines whether or not the node is to be displayed.

Furthermore, the present invention is also implemented as a graphics image generation method including the steps performed by the aggregation unit, filtering unit, and visualization unit described above, or as a data analysis method including the steps performed by the aggregation unit, filtering unit, and analysis result output unit described above.

Moreover, the present invention is also implemented as a program for controlling a computer to function as the graphics image generation apparatus or data analysis apparatus described above. The program can be provided by storing in a magnetic disk, optical disk, semiconductor memory, or other recording media and delivering the medium, or by distributing over a network.

Furthermore, according to the present invention, a graphics image can be output in which results of data analysis conducted based on a given aggregation or filtering criteria is properly reflected, therefore information obtained by data mining can effectively presented.

### BRIEF DESCRIPTION OF THE FIGURES

These and other aspects, features, and advantages of the present invention will become apparent upon further consideration of the following detailed description of the invention when read in conjunction with the drawing figures, in which:

FIG. 1 shows a configuration of a computer system functioning as a graphics image generation apparatus for displaying a graphics representation of hierarchical data according to an embodiment of the present embodiment;

FIG. 2 shows a functional configuration of the graphics image generation apparatus according to the present embodiment;

FIG. 3 shows an example of a category hierarchy to be processed according to the present embodiment;

FIG. 4 is a flowchart of a filtering process performed by a filtering unit according to the present embodiment;

FIG. 5 (A) is a diagram for illustrating an effect of a filtering process applied to the category hierarchy shown in FIG. 3 in which nodes to be displayed are selected using given filtering criteria;

FIG. 5 (B) is a diagram for illustrating an effect of a filtering process in which nodes to be displayed are selected using aggregation criteria;

FIG. 6 shows a functional configuration of a visualization unit according to the present embodiment;

FIG. 7 shows a concept of a template used for generating a graphics image according to the present embodiment;

FIG. 8 shows the coordinates of the four vertices of an arrangement that are normalized according to a template;

FIG. 9 shows a circle circumscribing a triangular element of a triangular mesh used for placing a rectangular representing a node of a graphics image;

FIG. 10 shows triangular elements of a triangular mesh along with the number of dummy vertices that the triangular elements touch;

FIG. 11 is a diagram for illustrating how rectangles are placed using a template;

FIG. 12 is a diagram for illustrating a method for extracting a triangular mesh element for determining the position at which a rectangle is to be placed;

FIG. 13 is a diagram for illustrating a method for determining possible positions in an extracted triangular mesh element at which a rectangle is to be placed;

FIG. 14 is a diagram for illustrating a method for placing a rectangle in a triangular element selected as a position at which the rectangle is to be placed;

FIG. 15 is a diagram for illustrating a process for expanding an arrangement area in order to place a rectangle;

FIG. 16 is a flowchart illustrating an outline of a whole process for generating a graphics image according to the present embodiment;

FIG. 17 shows changes of nodes of hierarchical data that are to be displayed and the corresponding changes in a visualization;

FIG. 18 shows a functional configuration of a graphics image generation apparatus capable of providing a GUI using a generated graphics image;

FIG. 19 shows an example of a graphics image generated from a given category hierarchy according to the present embodiment;

FIG. 20 is an example of a graphics image generated from the same category hierarchy shown in FIG. 19 by performing given filtering;

FIG. 21 shows a graphics image provided by reshaping bar graphs displayed on nodes in the graphics image shown in FIG. 20; and

FIG. 22 shows an example in which filtering is applied to a graphics image generated from given hierarchical data the nodes of which are rearranged.

Description of Symbols

10 . . . Computer system
11 . . . Processor (CPU)
12 . . . Main memory
13 . . . Video memory
14 . . . Display unit
15 . . . Storage device
100 . . . Aggregation unit
200 . . . Filtering unit
300 . . . Visualization unit
310 . . . Sorting unit
320 . . . Node arranging unit
330 . . . Arrangement control unit
340 . . . Bar graph generation unit
350 . . . Template holding unit
400 . . . Data storage unit

### DESCRIPTION OF THE INVENTION

The present invention provides a graphics display apparatus, system and method for effectively presenting information obtained by data mining. It also improves the visibility of the display of each individual data element and attributes of data included in a particular category while allowing an overview of whole large-scale hierarchical data to be provided.

In an example embodiment, the present invention is implemented as a graphics image generation apparatus which visualizes a hierarchical structure of hierarchical data and presenting the visualized data and is configured as follows. The graphics image generation apparatus includes an aggregation unit for performing aggregation of attributes of nodes in the hierarchical data according to given aggregation criteria; a filtering unit for filtering the result of aggregation performed by the aggregation unit according to given filtering criteria to select nodes to be displayed from the hierarchical data; and a visualization unit for generating a graphics image that includes the nodes selected by the filtering unit and reflects the hierarchical structure of the hierarchical data. More specifically, the aggregation unit obtains an aggregate value for a given node in the hierarchical data, the aggregate value being the result of aggregation of an attribute of the given node, and obtains a summarized aggregate value by summarizing aggregate values for descendant nodes of the given node into the aggregate value of the given node. The filtering unit replaces an aggregate value of a node that is determined as being ineligible to be displayed according to the given filtering criteria with the summarized aggregate value and determines whether or not the node is to be displayed.

The filtering unit determines, on the basis of the degree of meeting the aggregation criteria in the aggregation unit, the order in which determination is made on nodes in the hierarchical data as to whether the nodes are to be displayed by using the summarized aggregate value.

The present invention is also implemented as a data analysis apparatus that analyzes a set of data stored in a database and is configured as follows. The data analysis apparatus includes an aggregation unit for aggregating, according to given aggregation criteria, attributes of data classified in a give category system having a hierarchical structure; a filtering unit for filtering the category system according to given filtering criteria by using the result of aggregation by the aggregation unit to select valid categories according to the filtering criteria; and an analysis result output unit for generating and displaying a graphics image that includes the valid categories selected by the filtering unit and represents attributes of data included in the valid categories with visual elements.

More specifically, the aggregation unit aggregation unit obtains an aggregate value for a give category in the category system, the aggregate value being the result of aggregation of an attribute included only in the category, and obtains a summarized aggregate value by summarizing aggregate values of attributes of data included in a lower-level category of the category. The filtering unit replaces an aggregate value of a category that is determined as being invalid according to the given filtering criteria with the summarized aggregate value and determines whether or not the category is valid.

The data analysis apparatus may further include an event extraction unit for extracting a given input operation on the visual element of the graphics image displayed by the visualization unit as an event for specifying a category including data corresponding to the visual element. In this case, the filtering unit performs filtering according to information indicating the specification of the category that has been extracted by said event extraction unit.

Furthermore, the present invention is also implemented as a graphics image generation method including the steps performed by the aggregation unit, filtering unit, and visualization unit described above, or as a data analysis method including the steps performed by the aggregation unit, filtering unit, and analysis result output unit described above.

Moreover, the present invention is also implemented as a program for controlling a computer to function as the graphics image generation apparatus or data analysis apparatus described above. The program can be provided by storing in a magnetic disk, optical disk, semiconductor memory, or other recording media and delivering the medium, or by distributing over a network.

According to the present invention configured as described above, the combination of filtering technology for hierarchical data in data analysis and data visualization technology allows a graphics image to be generated that displays data elements and attributes of a particular category with high visibility while providing an overview of the whole large-scale hierarchical data.

Furthermore, according to the present invention, a graphics image can be output in which results of data analysis conducted based on a given aggregation or filtering criteria is properly reflected, therefore information obtained by data mining can effectively presented.

An advantageous embodiment for carrying out the present invention (hereinafter referred to as an embodiment) will be detailed below with reference to the accompanying drawings. An overview of the present invention will be given first. The present invention uses a computer system to analyze hierarchical data and generate a graphics image that visually represents the results of the analysis. While any types of graphics images that can represent hierarchical data can be used, an approach will be used in the embodiment described below in which a hierarchical structure is represented in two-dimensional form by a set of nested areas that represent levels.

A nested graphics image is generated as follows. First, lowest-level data elements are located in a space in which the graphics image is to be generated (a space displayed on a display device; hereinafter referred to as a display space). Then, an area is created that encloses a set of data elements to represent the higher level immediately above. The areas thus generated are rearranged in the display space and a larger area enclosing the set of areas is generated to represent the higher level immediately above. This process is repeated recursively until the highest level of the hierarchical data is represented.

In other words, a graphics image of hierarchical data is generated by placing levels of data in order from lowest to highest.

FIG. 1 shows a configuration of a computer system functioning as a graphics image generation apparatus (or data analysis apparatus for analyzing data) for displaying hierarchical data in graphical form according to the present embodiment. Referring to FIG. 1, a computer system 10 comprises a processor (central processing unit) 11 that performs graphics display processing under the control of a program, a main memory 12 that stores a program controlling the processor 11, a video memory 13 and a display unit 14 for displaying a graphics image of hierarchical data generated by the processor 11, and a storage device 15 such as a magnetic disk device that stores data used for generating hierarchical data to be processed and graphics images.

The processor 11 is controlled by a program stored in the main memory 12 to read hierarchical data to be processed from the storage device 15, generate a graphics image (image data) of the hierarchical data, and store it in the video memory 13. The graphics image store in the video memory 13 is displayed on the display unit 14. The main memory 12 is also used as a stack for temporarily holding cells and clusters in the course of generation of a graphics image by the processor 11, which will be described later. On the other hand, programs and data stored in the main memory 12 can be saved in the storage device 15 as required.

Shown in FIG. 1 are only components for implementing the present embodiment. In practice, an input device such as a keyboard and mouse for inputting commands and data, an audio output arrangement and various other peripheral devices, an interface to a network, and the like are provided in addition to the components shown. Instead of reading from the storage device 15 as described above, hierarchical data and other data may be input from an external source over a network.

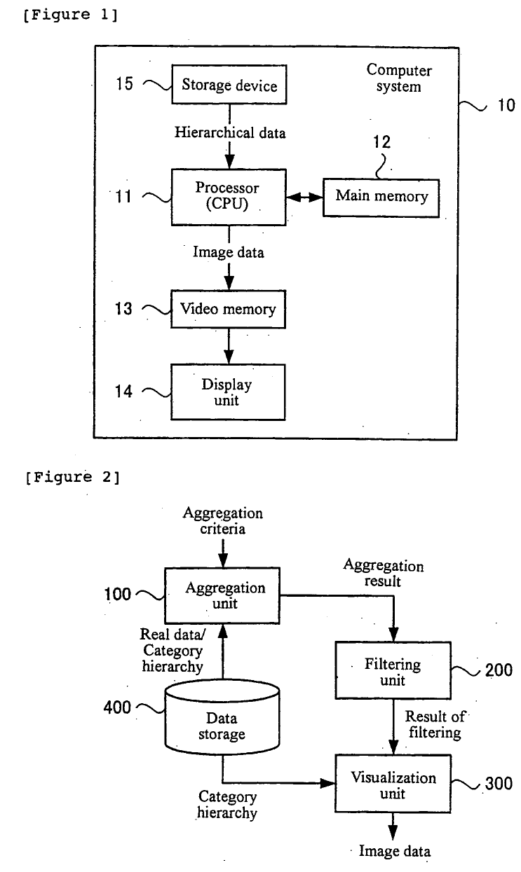

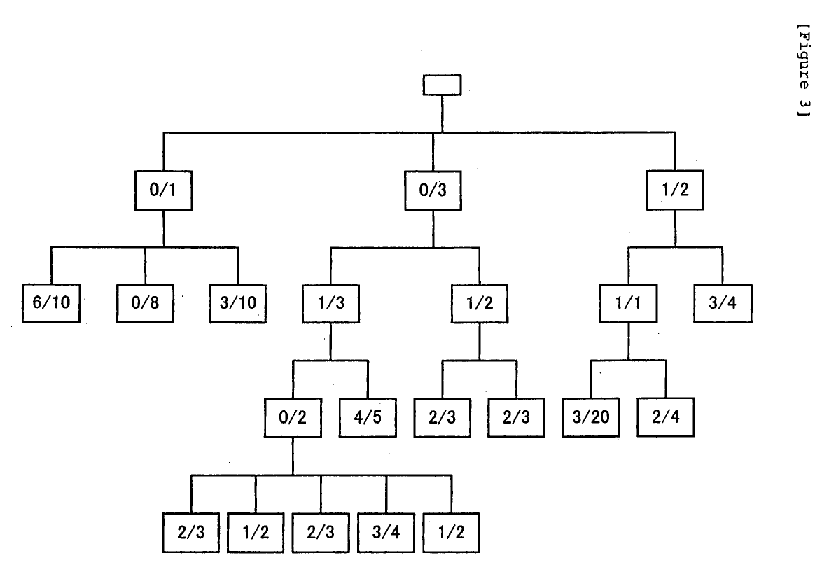

FIG. 2 shows a functional configuration of the graphics image generation apparatus according to the present embodiment. Referring to FIG. 2, the graphics image generation apparatus of the present embodiment comprises a aggregation unit 100 for compiling hierarchical data, a filtering unit 200 for performing filtering based on the result of aggregation by the aggregation unit 100, and a visualization unit 300 for generation a graphics image.

Hierarchical data can be either individual pieces of real data (for example, individual research papers in research paper data base of the U.S. National Library of Medicine) or a category system (for example MeSHTerm in the document database of the U.S. National Library of Medicine) that defines a hierarchical structure. In this embodiment, a category system is treated as data to be displayed as a graphics image (hereinafter a category system, namely hierarchical data to be displayed is referred to as a category hierarchy).

FIG. 3 shows an example of a category hierarchy. As shown in FIG. 3, a category hierarchy has a hierarchical structure branching from a root node. A number Y (denominator) of numbers X/Y indicated at each node represents the number of pieces of data belonging to the category at the node and the other number X (numerator) represents the number of pieces of data that meets a given aggregation criteria in the pieces of data belonging to the category at the node. After Y pieces of data are narrowed down to X pieces of data that match given criteria, the higher the ratio X/Y, the stronger the correlation between the category at the node and the aggregation criteria (however, if the number of pieces of data in a category is too small, the category should be considered as noise).

As shown in FIG. 2, real data and hierarchical categories are stored in a data storage 400. The data storage 400 may be implemented in the storage device 15 of the computer system 10 shown in FIG. 1, as described above or may be an external device accessible over a network. Each piece of real data is assigned information indicating which category or categories in the category system represented by the category hierarchy the piece of data belongs to. One piece of real data may belong to more than one category.

The aggregation unit 100 may be implemented by the processor 11 of the computer system 10 shown in FIG. 1, for example. Real data and its category hierarchy are input from the data storage 400 into the aggregation unit 100 and the aggregation unit 100 performs a aggregation process relating to the attributes of real data included in each category based on given aggregation criteria. For example, if real data is a text file of a research paper, the aggregation unit 100 may aggregate the pieces of real data that include that character string from among the pieces of real data in each category. Aggregation criteria for aggregating all pieces of data in the category hierarchy may be specified. In such a case, X=Y in the category hierarchy shown in FIG. 3.

In the present embodiment, pieces of real data that match given criteria in each category are aggregated to obtain an aggregated value. In addition, the pieces of real data that meet the aggregation criteria in the categories below each category whose aggregate value has been calculated (the descendant nodes of the node corresponding to each category whose aggregate value has been calculated) are also aggregated to obtain an aggregation result (hereinafter called a summarized aggregate value). The aggregation results (aggregate values and summarized aggregate value), which represent attributes of the nodes, obtained in this way are stored in the main memory 12 or the storage device 15 shown in FIG. 1, for example, and used by the filtering unit 200.

The filtering unit 200 may be implemented by the processor 11 of the computer system 10 shown in FIG. 1, for example, and applies filtering to a target hierarchical data (category hierarchy) by using results of aggregation performed by the aggregation unit 100. The filtering is a conversion process that involves setting a threshold for aggregate values of categories, which are elements of hierarchical data, and providing categories the aggregate values of which exceed the threshold as valid for being displayed as a graphics image for filtering criteria of interest.

In the present embodiment, given to each node of hierarchical data is an aggregate value of the category corresponding to that node and, in addition, a summarized value of the aggregation values of its descendent nodes, as described above. Therefore, if a given node is not displayed as a result of filtering but its higher level node is displayed, an attribute of the given node can be reflected in the display of its higher level node.

There are various methods for generating a graphics image of hierarchical data, including a method using the visualization unit 300, which will be described later. One method is to display a bar graph representing attributes of nodes. That is, a bar that stands on a node is drawn. The height, shape, or color represents attributes of the node of a category corresponding to a cell (In the following description, an example will be described in which the height and color of a bar are used to represent attributes). For example, the height of a bar can represent the number of document files in each category in the document database of the U.S. National Library of Medicine and the color of the bar can represent the relative frequency for IBM TAKMI for biomedical documents. A relative frequency is a value obtained by dividing the occurrence ratio of a keyword in extracted document files by the occurrence ratio of the words in all document files. The relative frequency can be used as an indicator of how strong the keyword correlates with criteria.

Prior to filtering, the filtering unit 200 determines the height and color of a bar representing attributes of the node at each category based on the result of aggregation by the aggregation unit 100. Also, filtering criteria (an attribute and threshold) for filtering are input into the filtering unit 200. The filtering criteria, which will be display parameters used in generating a graphics image, may specifies the height of bars (in which case, bard higher than or equal to the specified height will be displayed) or the color of bars (in which case, bars of the specified color will be displayed), or a numerical value corresponding to an aggregate value.

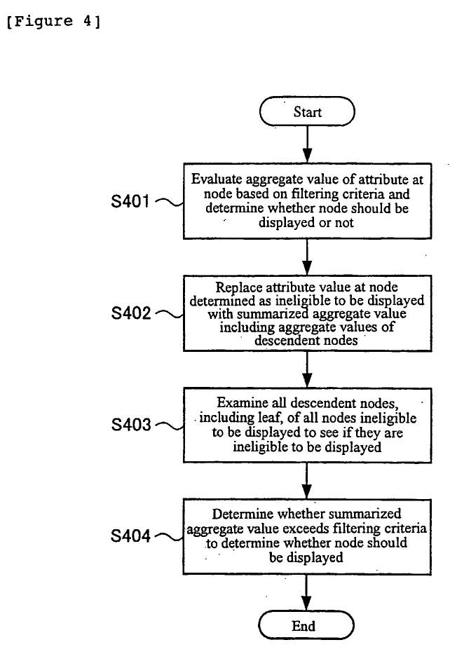

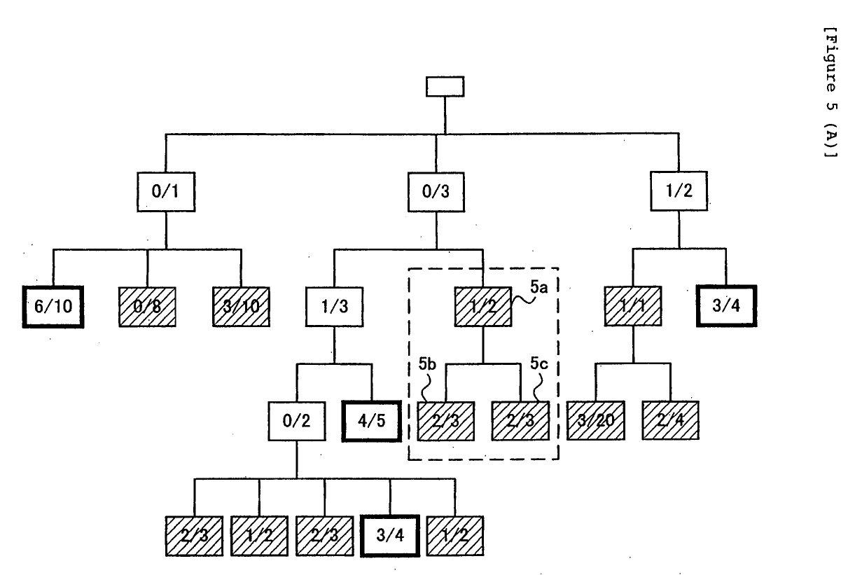

FIG. 4 is a flowchart of a filtering process performed by the filtering unit 200. As shown in FIG. 4, the filtering unit 200 determines, for each of the nodes of hierarchical data, whether or not attribute values of the node represented by the height and color of a bar exceed given filtering criteria, based on the aggregate value of the attributes of the node itself, to determine whether or not the node is eligible to be displayed (step 401).

Then, the filtering unit 200 replaces the aggregate value of the attributes of the nodes that have been determined as not eligible to be displayed at step 401 with a summarized aggregate value including aggregate values of attributes of its descendent nodes (step 402). The filtering unit 200 then determines, for each of the nodes determined as not eligible to be displayed, whether or not all of its descendent nodes, down to the leaf (the end or lowest-level node), are ineligible to be displayed (step S403). If all nodes below a given node are ineligible to be displayed, determination is made as to whether or not the attribute value (summarized aggregate value) at the given node exceed the filtering criteria to determine whether or not the given node should be displayed or not (step S404). The results of the filtering thus obtained (display node information) are stored in the main memory 12 or the storage device 15 shown in FIG. 1, for example, and used by the visualization unit 300.

Thus, the filtering makes it possible that only the nodes of the hierarchical data a given attribute of which exceeds a predetermined threshold will be displayed on a graphics image. The attribute of a displayed node reflects the attributes of the lower-level nodes below the nodes, as appropriate. That is, even if the aggregate value for a given attribute of a given category and all the categories below it is too low to exceed the threshold of filtering criteria, the given category will be displayed on a graphics image, provided that the aggregate value resulting from summarization of the aggregated values of them exceeds the threshold of the filtering criteria through the filtering.

Suppose that there are categories such as “Muscle pain in the leg” and “Muscle pain in the back” below the category “Muscle pain” in the category system of the U.S. National Library of Medicine. If the number of research papers that meets given aggregation criteria in each of the lower level categories “Muscle pain in the leg” and “Muscle pain in the back” does not exceed the threshold of filtering criteria but the number of research papers included in the higher category “Muscle pain” (namely the number of all the research papers that belong to the lower-level categories) exceeds the threshold of the filtering, the category “Muscle pain” will be displayed as a node (cell) on an graphics image.

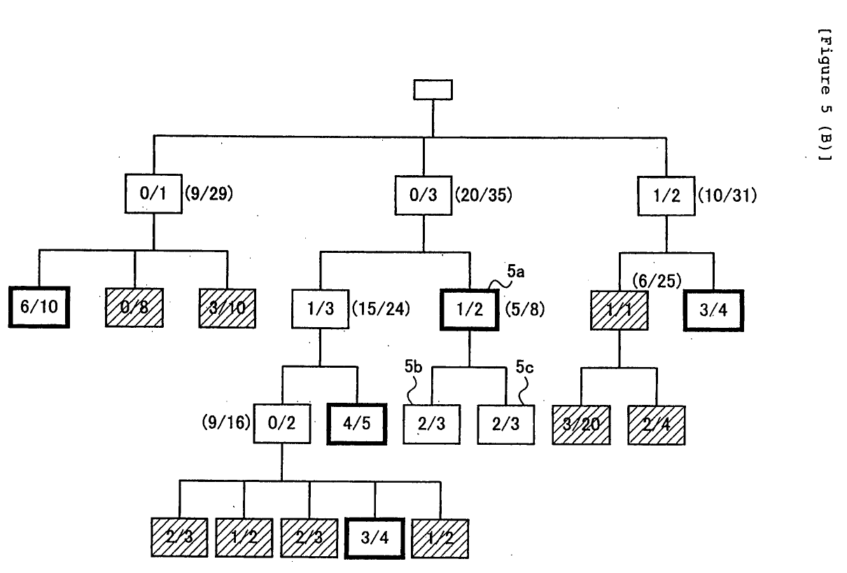

FIG. 5 illustrates an effect of filtering of the category hierarchy shown in FIG. 3. FIG. 5 (A) shows nodes that would be displayed based on filtering criteria that attributes of the nodes that include three or more matching pieces of data and has an X/Y ratio of 60% or more should be displayed. The nodes indicated by the thick-line boxes in FIG. 5 (A) meet the filtering criteria and therefore bars indicating attributes would be displayed for them. The nodes indicated by the thin-line boxes have descendant nodes that meet the filtering criteria and therefore would be displayed just as higher-level nodes. The hatched nodes do not meet the filtering criteria and therefore would not be displayed.

Now notice the nodes enclosed in dashed-line box. Node 5a of the three nodes, 5a, 5b, and 5c, is the node one level higher than nodes 5b and 5c. The categories at nodes 5b and 5c are included in the category at node 5a. An aggregate value indicating the relation between aggregation criteria at node 5b and 5c is contained in each node and node 5a contains an aggregate value relating to data that is not contained in node 5b and 5c. If the values at these nodes are evaluated as they are, none of nodes 5a, 5b, and 5c meet the filtering criteria. However, the aggregate values at nodes 5b and 5c should be taken into account when the aggregate value at node 5a is evaluated because node 5a is the higher-level node of nodes 5b and 5c.

In the present embodiment, therefore, provided to a higher-level node of a hierarchical structure is, in addition to its own aggregate value, a summarized aggregate value obtained by summing up aggregate values at its lower-level nodes, as described earlier. If all of the lower-level nodes are determined as being ineligible to be displayed, then determination is made as to whether the summarized aggregate value at the higher-level node exceeds filtering criteria.

FIG. 5 (B) shows the nodes after summarized aggregate values are provided to all nodes that have lower nodes in the category hierarchy shown in FIG. 5 (A). Numerals (P/Q) shown near each node indicate a value obtained by summing up the aggregate values at it child nodes. Q (denominator) represents the number of all pieces of data belonging to the category at each node and P (numerator) represents the number of pieces of data that meets given aggregation criteria in the pieces of data belonging to the category at each node. At node 5a in FIG. 5 (B), the summarized aggregate value is ⅝. The node 5a therefore meets the filtering criteria that attributes of the nodes include three or more matching pieces of data and has an X/Y ratio of 60% or more should be displayed. Consequently, a bar indicating an attribute will be displayed for this node 5a.

A visualization unit 300 is implemented by the processor 11 and storage device 15 in the computer system 10 shown in FIG. 1, for example. A category hierarchy is input from the data storage 400 into the visualization unit 300, which then generates a graphics image based on the result of aggregation by aggregation unit 100 and the result of filtering by the filtering unit 200. In other words, the visualization unit 300 is analysis result output means that outputs a visual representation of results of data analysis of hierarchical data conducted by the aggregation unit 100 and the filtering unit 200. Because the result of data analysis is displayed in such a manner that an overview of the entire hierarchical data is presented while attributes of each individual node (category) are represented in visible form, the information obtained by data mining can effectively presented.

As described earlier, a graphics image of hierarchical data (category hierarchy) is generated by nesting areas representing levels. In the graphics image, each data element (a category corresponding to a node at the lowest level displayed) in the hierarchical data is called a cell. The cells are represented by squares of the same size.

A node at a higher level (higher-level category) that represents a category to which data elements belong is called a cluster and is represented by a rectangle that encloses cells and lower-level clusters. That is, the graphics image is made up of one or more rectangular clusters and square cells arranged in the cluster or clusters. However, cells and clusters are nested simple square and rectangular graphics at the stage where the graphics image is being generated, and therefore can be treated in the same manner. Therefore, unless there is necessity to distinguish between cells and clusters in the following description, cells and clusters are generically called nodes. While the present embodiment will be described by mainly using an example in which rectangular clusters, which can take various sizes, are arranged, the same description applies to a case where cells are arranged if the cells are not limited to the same size, because cells and clusters are treated in the same way, as described above.

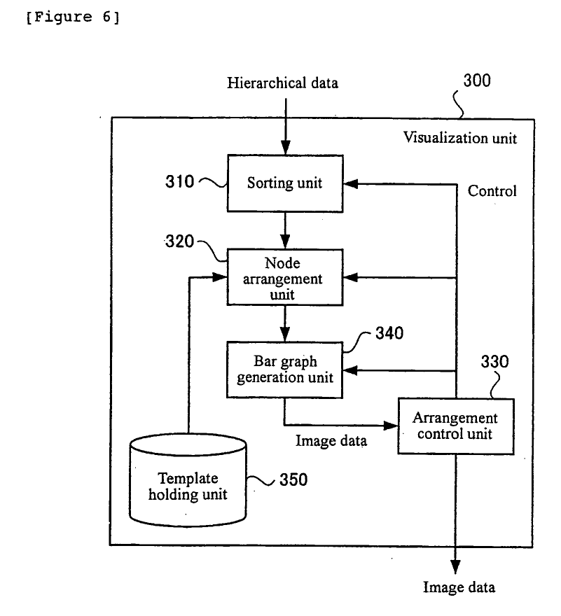

FIG. 6 shows a functional configuration of the visualization unit 300. As shown in FIG. 6, the visualization unit 300 comprises a sorting unit 310 for determining the order in which nodes at each level of hierarchical data are placed, a node arrangement unit 320 that arranges nodes of hierarchical data according to the order determined by the sorting unit 310, an arrangement control unit 330 that causes arrangement of nodes of hierarchical data by the sorting unit 310 and the node arrangement unit 320 to be recursively performed sequentially, starting from the lowest level of the hierarchical data, a bar graph generation unit 340, and a template holding unit 350.

In the configuration shown in FIG. 6, the sorting unit 310 determines (sorts) the order of arrangement of clusters or cells to be arranged in a rectangular representing a higher-level cluster. The order is determined according to a template stored in the template holding unit 350. The concept of the template will be described below.

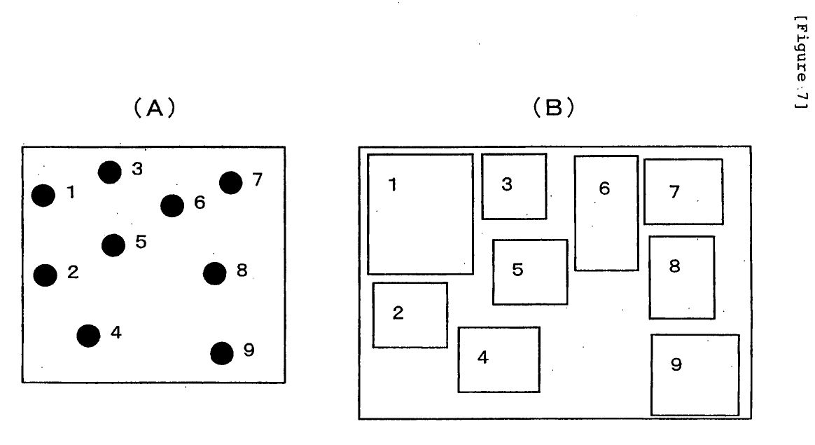

FIG. 7 shows the concept of the template. FIG. 7 (A) shows an example of a template for one level having nine nodes. A template represents information about the positions of nodes. The size of the template corresponds to the size of area in which nodes to be arranged (arrange area, which will be detailed later) and given coordinates (x-y coordinates, for example) are set in the template. The coordinate values can be used to identify the position in the arrangement area at which a node should be placed. When the template is created, it is not required that the size of the rectangles representing the nine nodes is known. Furthermore, fluctuations in density of nodes in the template pose no problem. FIG. 7 (B) shows the result in which nine rectangles that correspond to the nodes and have given sizes according to the template are arranged. It can be seen that the rectangles are arranged in such a manner that the relation among them, which is specified in the template, is maintained, they do not overlap each other, and not occupy too large space.

In the present example embodiment, when a number of graphics images of the same hierarchical data are generated with different aggregate criteria or filtering criteria, the first or previous graphics data generated (hereinafter referred to as an original image) can be used as a template for rearranging nodes to enhance the visibility of each individual nodes or bar graph. In particular, the position of each cell placed in the original image is expressed by coordinates and nodes making up a new graphics image are placed based on the coordinates. Thus, when different graphics images based on different aggregation criteria or filtering criteria or nodes are rearranged, corresponding nodes can be placed in the positions same as or as closest to their original position as possible.

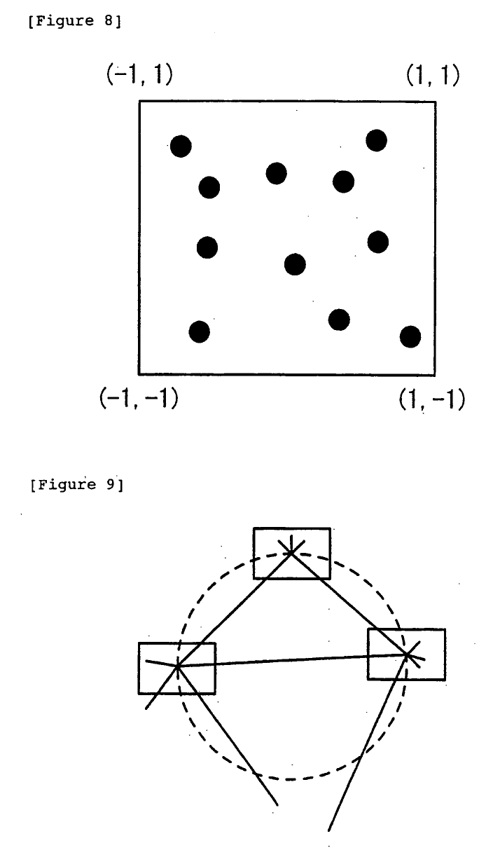

The sorting unit 310 first normalizes the coordinates of the four vertices of an arrangement area (having the same size as the template) in which nodes are to be placed as: (−1, −1), (1, −1), (1, 1) and (−1, 1). This normalization is shown in FIG. 8. The sorting unit 310 then determines based on given criteria the order in which the nodes the positions of which are specified by coordinates in the template. The criteria for determining the order can appropriately be set according to the meaning of the positions of the nodes that are identified in the template. For example, nodes may be arranged in ascending order of x-coordinate value or in the order of normalized coordinates, from nearest to the origin point to farthest. If there is no template or if nodes that are not contained in a template (newly added nodes) are to be arranged, the nodes are arranged in the order of their area, the largest first. In the present embodiment, cells corresponding to data elements are squares of the same size. Therefore, they can be arranged in any order. If an approach to representation is used in which the size of a cell reflects the content of its corresponding data element, the order of cells may be determined according to the size of the cells. The result of sorting that indicates the arrangement order of clusters or cells is temporarily stored in the main memory 12 or a register in the processor 11.

The node arrangement unit 320 places nodes (clusters or cells) of hierarchical data in a display space in the order sorted by the sorting unit 310. The position in which a node is placed is determined based on the following criteria:
[Criterion 1]: a position that does not overlap rectangles already placed.
[Criterion 2]: a position at a distance D as close to a reference position specified in the template as possible.
[Criterion 3]: a position at which the expansion amount S of the area occupied by the rectangle is as small as possible.

A position that surely meets [Criterion 1] and satisfies [Criteria 2 and 3] as much as possible is located. In the present embodiment, a position that provides the smallest aD+bS (where a and b are constants defined by a user) is considered as the position that best meets criteria 2 and 3. By setting constants a and b as appropriate, priorities can be assigned to [Criteria 2 and 3].

If there is no template, the node arrangement unit 320 in the present embodiment arranges rectangles in the display space in the order sorted by the sorting unit 310 by following the following policy:
(1) Rectangles should be arranged in the order starting from the center of the display space and adjacent to a rectangle already placed.
(2) If a rectangle can be placed in a gap between rectangles previously placed, it should be placed in the gap.

In the present embodiment, in order to quickly find a gap in which a rectangle can be placed as required by the policy (2), a triangular mesh that connects the center points of rectangles is used. The triangular mesh should meet the Delaunay condition.

Furthermore, when the node arrangement unit 320 places a cluster of a given level, the clusters and cells at the lower levels below that cluster have already been arranged because the nodes in hierarchical data are arranged in the order from lowest to highest level in the present embodiment. Therefore, when placing a given cluster, the node arrangement unit 320 stores the physical relation of the rectangular representing that cluster to lower-level rectangles or squares previously placed. That is, the node arrangement unit 320 treats these graphics as one graphic and performs arrangement.

The arrangement control unit 330 causes arrangement of clusters or cells by the sorting unit 310 and the node arrangement unit 320 on a level by level basis to be recursively performed, starting from the lowest level of the hierarchical data, thereby generating a graphics image of the entire hierarchical data. The graphics image generated is stored in the video memory 13 shown in FIG. 1 and displayed on the display device 14.

According to the present embodiment, filtering by the filtering unit 200 can control which nodes are displayed on a graphic image. Nodes to be displayed can dynamically be changed by changing filtering criteria, which is a display parameter. When filtering is performed with changed filtering criteria in the filtering unit 200, the arrangement control unit 330 controls the sorting unit 310 and the node arrangement unit 320 to rearrange nodes and regenerate a graphics image.

The bar graph generation unit 340 generates on a cell (a node at the lowest level) arranged by the arrangement control unit 330 a bar graph representing an attribute of the node of the category corresponding to that cell based on the result of aggregation by the aggregation unit 100 and the result of filtering by the filtering unit 200. As described earlier, a display property such as the height or color of a bar is associated with an attribute of the node. The bar graph is displayed on the cell when a graphics image is displayed.

According to the present embodiment, when a display configuration of a graphics image is dynamically changed by filtering of the filtering unit 200, a bar graph can be reshaped as appropriate. Reshaping of a bar graph will be detailed later.

The template holding unit 350, which may be implemented by the storage device 15 of the computer system 10 shown in FIG. 1, for example, holds a template which is referred to by the node arrangement unit 320 when arranging nodes. In the present embodiment, a template is created according to a given rule as described above, and thereby meaning can be given to the position of a data element or similar arrangements can be provided for data having similar meaning. A graphics image generated can be stored in the template holding unit 350 and used as a template for generating the next graphics image.

A process for generation a graphics image of hierarchical data in the configuration described above will be described below.

How the position at which a rectangle (cluster) should be placed is located using a triangular mesh will be described first. In the present embodiment, if a number of rectangles have been placed, an area that is not crowded with rectangles is found and the next rectangle is placed there. This process is repeated to arrange rectangles in a small space. In order to extract an uncrowded area, a triangular mesh that connects the center points of the previously placed rectangles is generated in an area in which the rectangle is to be placed. An area in the triangular mesh in which a large rectangular element is generated is likely to be uncrowded. Therefore, placement of a new rectangle in the area is tried. Criteria for determining the size of a rectangular element may be the radius of the circle circumscribing the triangular element, the radius of the circle inscribed in the triangular element, or the maximum value of the three sides of the triangular element. In the following description, an example is used in which the size of a rectangular element is determined based on the radius of the circle circumscribing the element.

The area in which a rectangular is to be placed is a rectangular area representing a cluster one level higher than the rectangle (cluster) to be placed (the arrangement area in this sense is called a graphic area). Therefore, four dummy vertices are placed at appropriate positions in a display space to reserve a rectangular arrangement area and the coordinates of the four vertices v₁, v₂, v₃, and v₄ of the arrangement area are set as (−1, −1), (1, −1), (1, 1), and (−1, 1). A diagonal line is drawn between two vertices to generate a triangular mesh consisting of two triangular mesh elements. Because no rectangle is placed at this point, a triangular mesh is generated such that the rectangular arrangement area is divided into two triangles. Each time a rectangle is placed, the center point of that rectangle is added as a new vertex. In this way, the triangular mesh is made finer.

In the initial state, the first rectangle can be placed in anywhere in the arrangement area because no rectangle has been placed previously. In this example, it is assumed that a rectangle is placed at the center of an arrangement area indicated by dummy vertices.

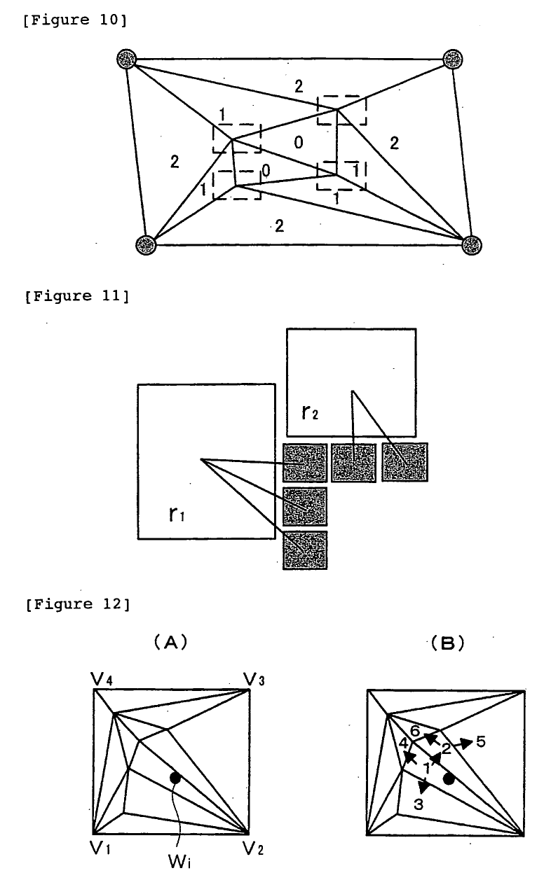

FIG. 9 shows the circle circumscribing a given triangular element in a triangular mesh that connects the center points of rectangles previously placed. In the triangular mesh that satisfies the Delaunay condition, there are no other vertices of the rectangular element within the circumcircle indicated by the dashed circle in FIG. 9. Therefore, it can be estimated that the density of the vertices of a triangular element near a triangular element whose circumcircle is large is small. A small density of a triangular element in a given area means that the number of rectangle is small.

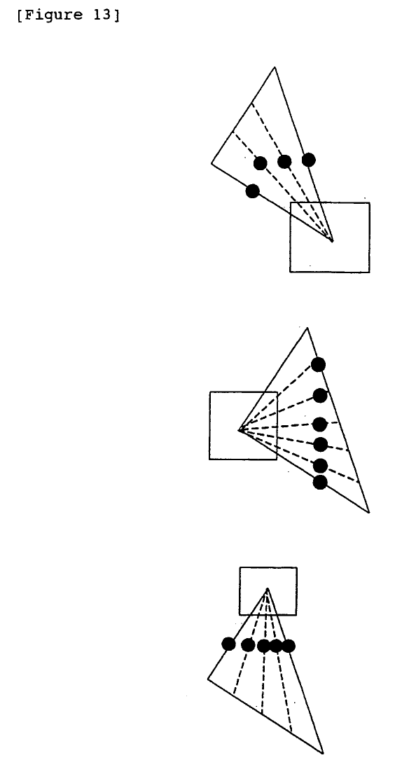

FIG. 10 shows triangular elements of a triangular mesh along with the number of dummy vertices that the triangular elements touch. A triangular element can be said to touch a dummy vertex when any of the vertices of that triangular element touches the dummy vertex. Therefore, the number of dummy vertices that a triangular element touches is a value ranging between 0 and 3 (If the number of dummy vertex that a triangular element touch is 3, that is, if all the vertices of the triangular element coincide dummy vertex, a triangular mesh has been generated in which the arrangement area indicated by the dummy vertices is separated into two by a diagonal line. In the example shown in FIG. 10 in which a finer triangular mesh has been generated, the maximum number of dummy vertices a triangular element touch is 2). The dummy vertices are at the outmost edges of the triangular mesh. Therefore, it can be seen that a triangular element that touches a larger number of dummy vertices is in an outermost position of the area in which the triangular mesh has been generated and a triangular element that touches a smaller number of dummy vertices is in an inner position of the area. Placing a rectangular in the position of a triangular element that touches a smaller number of dummy vertices allows a number of rectangles to be put together in a smaller space. Thus, expansion of an arrangement area can be avoided.

Then, rectangles that represent nodes (hereinafter simply called rectangles) are placed within the triangular mesh one by one in order. As described earlier, the order in which the rectangles are placed is determine based on the coordinate values in a template that specify the locations of the rectangle in the present embodiment. Assume that rectangles r₁ and r₂ have been placed as shown in FIG. 11 and the next rectangle is placed at a position close to rectangles r₁ and r₂ and also close to the position specified by the coordinates specified in the template.

In the present embodiment, triangular elements at positions that are closer to the normalized coordinates on the template are extracted in order and a number of possible positions of a rectangle are set within an extracted triangular mesh element. Then, the rectangle is placed in one of the possible positions. This is repeated in several extracted triangular mesh elements to find one of the possible positions that meets [Criterion 1] and provides the smallest aD+bS. The position is chosen as the position in which the rectangle is to be placed.

FIG. 12 illustrates a method for extracting a triangular mesh element in order to determine the location of a rectangle. As shown in FIG. 12, a triangular mesh element that includes the coordinates of a rectangle to be placed that are specified on the template is identified (see FIG. 12 (A)). Using the triangular mesh element as the starting point, an adjacency breadth-first search is performed to extract a triangular mesh element (see FIG. 12 (B)). Then, possible positions of the rectangle are calculated in the order in which triangular mesh elements have been extracted. Because triangular mesh elements are extracted in order of position the closest to the template coordinates first, value aD increases with the progress of the process. Therefore, in the present embodiment, the repetitive process is terminated when aD value exceeds the minimum value of aD+bS values recorded.

FIG. 13 illustrates the method for finding possible positions in an extracted triangular mesh element at which a rectangle is to be placed. As shown in FIG. 13, in order to calculate possible positions at which the rectangle is to be place, line segments that connect a vertex of the triangular mesh element with the opposite side are generated at given sampling intervals. Then, a position at which the line segment touches a rectangle that has previously placed is selected as a possible position of the center of the new rectangle and the new rectangle is placed at that position. Such possible positions in a triangular mesh element are indicated herein as c₁-cₘ, where m is the number of the possible positions in the element. Then, one of the following steps is performed.
If rectangle rᵢ overlaps another rectangle that has been previously placed when the center vᵢ₊₄ of rectangle rᵢ is positioned at a possible position cⱼ, the rectangle is not placed at possible position cⱼ.
Value aD+bS at a possible position cⱼ is calculated. Value S may be the area of the rectangle or the length of the four sides of the rectangle. The smallest aD+bS value in the aD+bS values calculated for the rectangle rᵢ is recorded as (aD+bS)ₘᵢₙ. At the same time, the position cⱼ is recorded as position cₘᵢₙ.

These steps are repeated for each triangular mesh element. The center vᵢ₊₄ of the rectangle is placed at the position Cₘᵢₙ recorded after the repetition is completed. If there is no template, the first rectangle is placed in anywhere and then another rectangle is placed as described below.

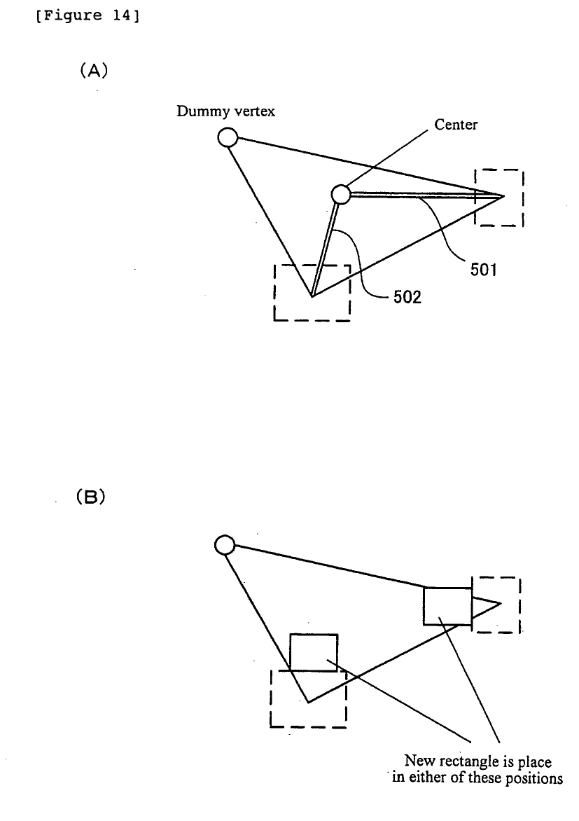

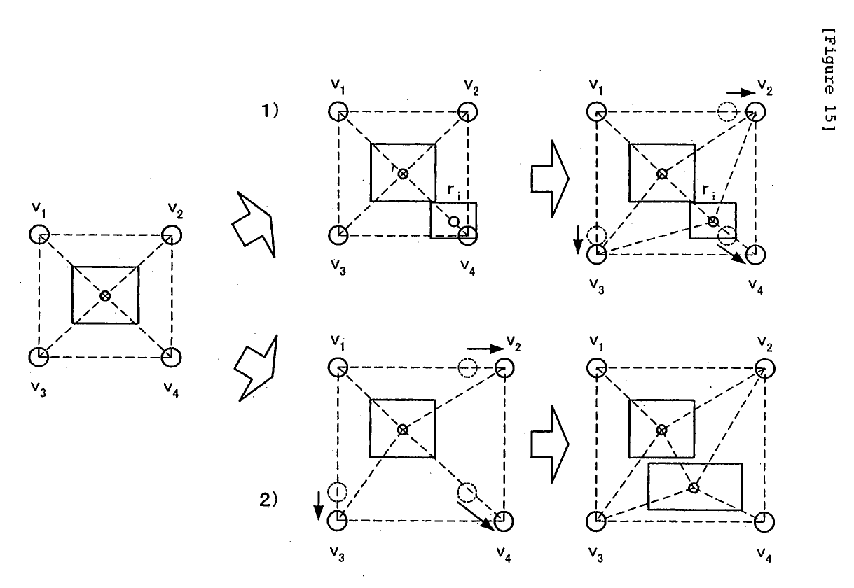

FIG. 14 illustrates a method for placing a rectangle in a triangular element selected as an element in which the rectangle is to be placed. In the example shown in FIG. 14, two rectangles indicated by dashed-line boxes have been already placed and a triangular element that touches one dummy vertex is selected as an element in which a new rectangle is to be placed. The new rectangle is placed so that the center of the rectangle is positioned on a line segment (segment 501 or 502 in FIG. 14 (A)) that connects the center of the selected triangular element and a vertex of the triangular element other than the dummy vertex, and the new rectangle becomes adjacent to one of the already placed rectangle. That is, the rectangle is placed at one of the positions indicated by two solid-line rectangles in FIG. 14 (B).

A process for expanding an arrangement area in which a rectangle is to be placed will be described below. In the present embodiment, any of the four vertices v₁, v₂, v₃, and v₄ of an arrangement area is moved to expand the arrangement area if:
(1) a part of a rectangle rᵢ placed at a position cₘᵢₙ determined through the process describe above lies off an arrangement area defined by the four vertices v₁, v₂, v₃, and v₄, or
(2) no cₘᵢₙ is recorded, or in other wards, no possible position that meets [Criterion 1] is found. In either case, the area is expanded and then the above-described process performed again from the calculation of possible positions.

FIG. 15 schematically shows the method for expanding an arrangement area in the two cases described above. The four vertices of the arrangement area are moved appropriately to expand the arrangement area so that a rectangle to be placed fits in the arrangement area. After the arrangement area is expanded, the coordinates of the vertices of the triangular mesh on the template are re-normalized.

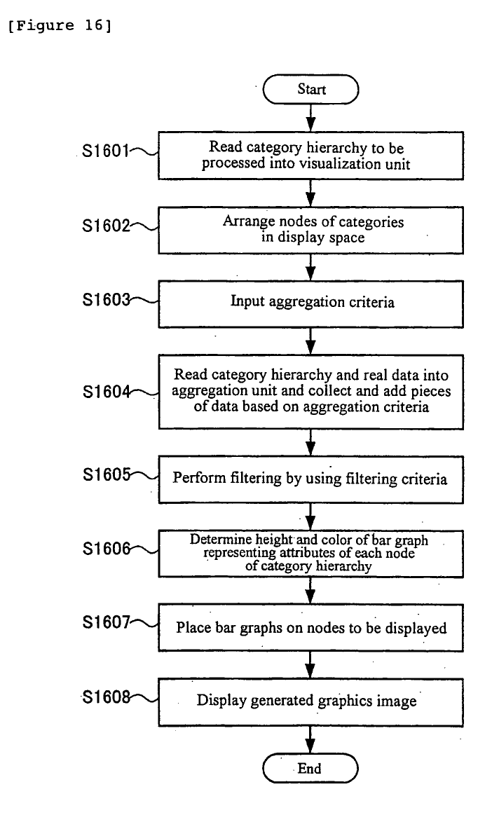

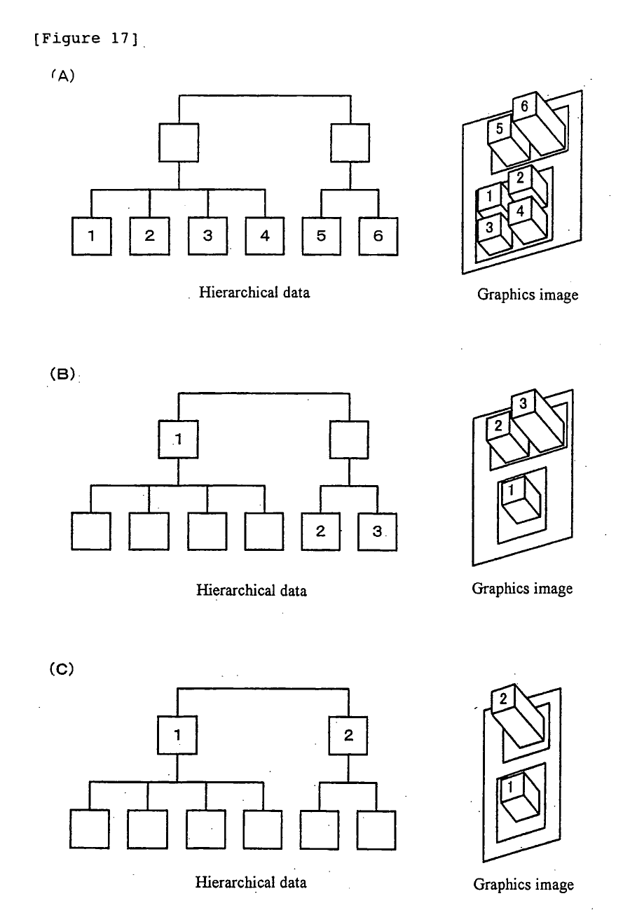

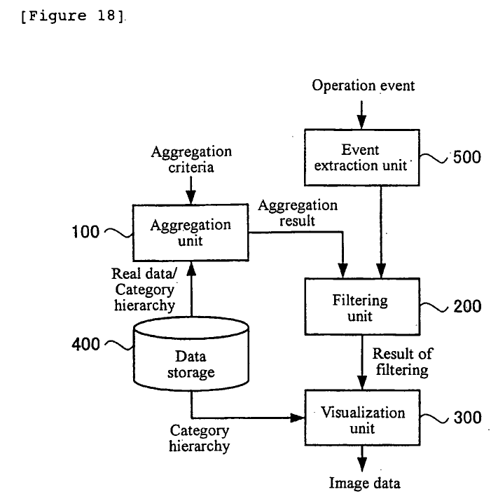

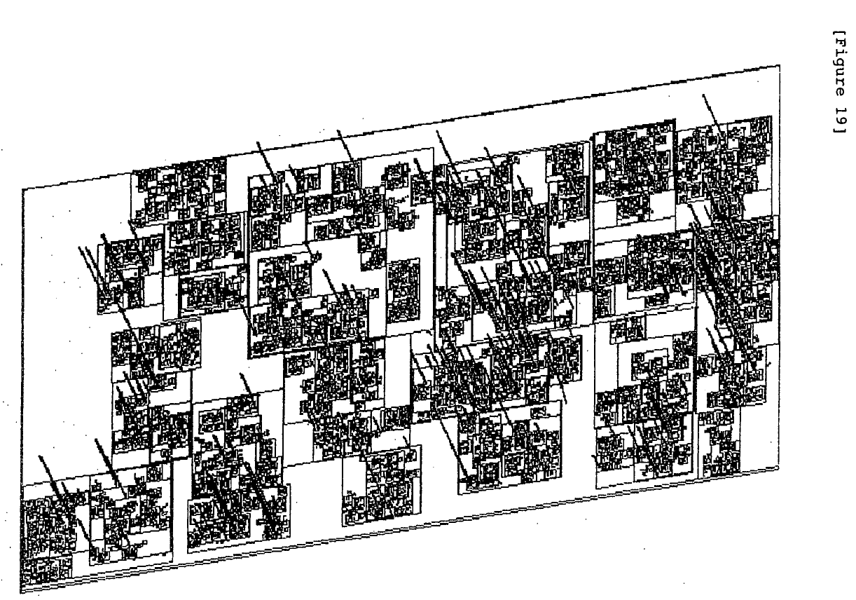

FIG. 16 is a flowchart illustrating an outline of a whole process for generating a graphics image according to the present embodiment configured as described above. Referring to FIG. 16, a category hierarchy, which is hierarchical data to be processed, is read from the data storage 400 into the visualization unit 300 (step 1601) and the nodes of the categories are arranged in a display space (step 1602). The initial graphics image generated at this point is held in the template holding unit 350 of the visualization unit 300.

When an aggregate criterion is input into the aggregation unit 100 (step 1603), then the category hierarchy and real data classified by the category hierarchy is read from the data storage 400 to the aggregation unit 100, where pieces of data are collected and added according to a collection criterion (step 1604). As described earlier, the aggregate value of the node of each category is calculated and a summarized aggregate value is calculated by adding aggregate values of its descendant nodes. These values are assigned to the node. The aggregation result is stored in storage means such as the main memory 12 or the storage device 15 shown in FIG. 1.

While the aggregation is performed at steps 1603 and 1604 after the nodes are arranged at steps 1601 and 1602 in FIG. 16, the arrangement steps are independent of the aggregation steps and therefore the order is not limited to this. The aggregation steps may be performed first or the arrangement and aggregation may be performed in parallel.

The result of aggregation by the aggregation unit 100 and the category hierarchy are input into the filtering unit 200, where filtering is performed by using a filtering criterion (display parameter) and nodes to be displayed are determined (step 1605). The details of the filtering have been describe earlier with reference to FIG. 4.

The visualization unit 300 determines the height and color of a bar graph of each node of the category hierarchy that represent attributes of that node according to the result of filtering performed by the filtering unit 200 (step 1606). Then, bar graphs are placed on the nodes to be displayed in the graphics image generated at step 1602 (step 1607). If required, nodes are rearranged and bar graphs are reshaped according to the result of filtering.

After the bar graphs are placed, the generated graphics image is stored in the video memory 13 and output and displayed on the display unit 14 (step 1608).

A user looks at the graphics image displayed on the display unit 14 and changes a filtering criterion (display parameter) and re-generates the graphics image as required. This operation (steps S1605-1608) can be repeated to obtain a desired (easy to look at) graphics image.

The visualization unit 300 of the present embodiment can use a template to restrict the positions in which nodes are to be placed and thereby generate a graphics image as described above. Therefore, when a filtering criterion is changed to re-generate a graphics image, the graphics image previously generated for the same category hierarchy can be used as a template to generate a graphics image in which corresponding nodes are placed at approximately same positions.

FIG. 17 shows changes of nodes of hierarchical data that are to be displayed and the corresponding changes in a visualization (graphics image). In FIG. 17, graphics images are shown as they are seen when the display space is viewed from an angle, in order to make bar graphs three-dimensional.

The hierarchical data shown in FIG. 17 consists of two layers. One of two higher-level nodes has four lower-level nodes and the other has two lower-level nodes. FIG. 17 (A) shows data before filtering or data in which attributes of all lower-level nodes meet a filtering criterion. All of six lower-level nodes have been selected as eligible to be displayed. Consequently, cells corresponding to the lower-level nodes are placed in two clusters representing the higher-level nodes and six bars in total are displayed in the graphics image.

FIG. 17 (B) shows hierarchical data in which the upper-level node in the left-hand part of the hierarchical data is selected as eligible to be displayed as a result of filtering. Consequently, in its graphics image, a bar graph representing an attribute (a summarized aggregate value) of the upper-level node corresponding to the cluster in concern is displayed in the cluster for which four bar graphs were displayed in the graphics image in FIG. 17 (A).

FIG. 17 (C) shows data in which none of attributes of the lower-level nodes meet a filtering criterion and the two higher-level nodes have been selected as eligible to be displayed as a result of filtering. Consequently, in its graphics image, bar graphs representing attributes (summarized aggregate values) of the higher-level nodes are displayed in the two clusters that represented the higher-level nodes in FIG. 17 (A).

In the process shown in FIG. 16, filtering is used to generate a graphics image of data that meets one aggregate criterion. However, various aggregate criteria can be used for the same category hierarchy to re-generate a graphics image, and thereby new insights can be obtained. Of course, if a fixed filtering criterion is used, a completely different graphics image can be generated by changing aggregate criteria.

An overview of a whole graphics image of a large-scale database can be displayed in visible form by performing filtering in this way to exclude some of the lower-level categories appropriately. And yet, attributes of the excluded lower-level categories can be reflected in the graphics image, without being lost.

For analysis such as data mining, interactive operations such as mouse-clicking a displayed visual object such as a dot, line, or bar to obtain real data corresponding to a node or display a label are useful and essential, besides obtaining insights only from visual features. In order to provide such enhanced functions, it would be effective to reshape a graphics image appropriately to enhance the visibility of the whole image or to enhance the clickability of a visual object of interest, in addition to applying filtering to reduce the number of displayed elements.

Therefore, a GUI (Graphical User Interface) is provided by using a graphics image generated according to the present embodiment. The GUI includes a function for specifying a node (cell or cluster) by clicking a corresponding bar graph displayed in a graphics image or a rectangle representing that node. This function may be provided by adding an event extraction unit 500, for example, to the graphics image generation apparatus of this embodiment shown in FIG. 2 that extracts as an event a mouse click on a visual object such as a dot, line, or bar displayed in a graphics image. The event extraction unit 500 may be implemented by the processor 11 of the computer system 10 shown in FIG. 1, for example. The GUI can be used to implement operations such as specify a given node to cause the nodes that provide aggregate values higher than that of the specified node.

In order to implement an operation that uses the GUI, a preprocess is performed for determining the order in which filtering is focused on nodes to select nodes to be displayed. In particular, the order may be determined as follows.

A threshold for an aggregate value is assumed as filtering criteria and a higher-level node is searched for at which the aggregate value of a lower-level node is summarized when filtering is performed using that threshold. The search is repeated by increasing the threshold progressively. Thus, the located nodes are ordered in the order in which they have been located. That is, the first node located becomes the last in order and the last node located becomes the first. This ordering can be said to indicate the degree of meeting aggregation criteria in the aggregation unit 100. The aggregate values of the ordered parent nodes and summarized aggregate values at those parent nodes are recorded.

Thus, the order in which nodes to be displayed are searched for during filtering is determined. Consequently, if filtering criteria is given, determination as to whether each of the nodes meets the filtering criteria is made by following the order, and thus whether or not the node should be displayed is determined.

It is assumed that a graphics image of hierarchical data to which the preprocess described above was applied has been generated and displayed on the display unit 14 shown in FIG. 1, for example. When a user looks at the graphics image displayed and clicks with a mouse on a rectangle or bar graph of a given node, the event extraction unit 500 extracts the mouse click as an event for specifying the node corresponding to the rectangle or bar graph clicked and provides the indication of the event to the filtering unit 200. When receiving the indication from the event extraction unit 500 that the node has been specified, the filtering unit 200 searched through the nodes from the root node to lower-level nodes of the hierarchical data in the order determined in the preprocess described above and selects the nodes, from the root to the node specified by the mouse click, as nodes to be displayed. Then, the visualization unit 300 generates a graphics image including the new nodes to be displayed as its elements. In this way, a GUI operation is implemented that re-generates a graphics image in which the nodes having higher aggregate values than that of the node clicked are displayed. Because mouse-clicking a rectangle or bar graph in a graphics image specifies the node corresponding to the clicked rectangle or bar graph, a GUI operation can be readily implemented that reads real data (for example a document file) associated with the specified node in the category hierarchy from a data storage 400.

Furthermore, the preprocess for determining the order in which nodes to be displayed are located as describe above can be used for operations other than GUI operations. For example, after the preprocess, filtering criteria for displaying x nodes that provide top x aggregate values is used to search through hierarchical data from the root node to lower-level nodes in the order determined in the preprocess until the specified x number is reached, then the search is ended and a graphics image is generated by using the nodes located as nodes to be displayed.

In the process for generating a graphics image according to the present embodiment, the combination of filtering of hierarchical data and information visualization as described above can avoid overcrowding of a generated graphics image on a display. Thus, important data can readily attract attention without diverting attention to less important data. However, when zooming out a display of large-scale data in order to provide an overview of the whole data, bar graphs displayed on nodes may become so thin that their heights or colors cannot be identified or they are hard to click, even if less important nodes are excluded from the display through filtering.

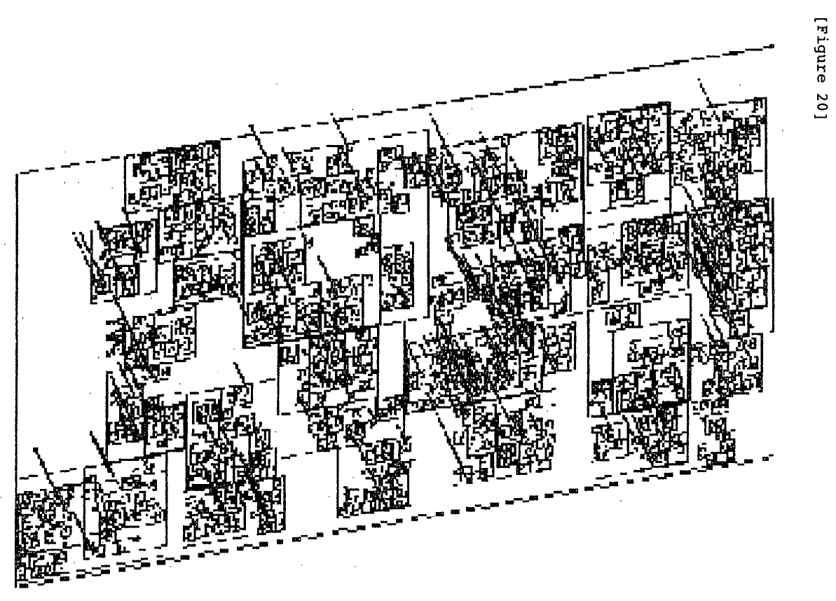

FIG. 19 shows an example of a graphics image generated from a given category hierarchy. FIG. 20 shows an example of a graphics image generated after filtering the same category hierarchy as shown in FIG. 19. The figures show the graphics images that are seen when the display space is viewed from an angle, in order to make bar graphs three-dimensional.

Comparing the figures with each other, the graphics image in FIG. 20 includes less nodes displayed and therefore is less crowded and more visible. However, the bar graphs displayed on nodes are still thin as in the image shown in FIG. 19 and accordingly attributes of the nodes that are represented by the bar graphs are not necessarily easy to identify.

Therefore, it is contemplated that a graphics image in which less important nodes are excluded by filtering and consequently becomes uncrowded as a whole is transformed in such a manner that the colors and heights of bar graphs can easily be recognized. For achieving this, the present embodiment proposes the approach of transforming the shape of bar graphs (first approach) and the approach of rearranging nodes according to the number of nodes displayed (second approach).

First Approach: Reshaping Bar Graphs:

In the first approach to making bar graphs more visible, each bar is represented by an inverted quadrangular pyramid whose cross-section area becomes gradually larger toward the top (if the bar is originally a quadrangle). Because the top of the bar is thicker, the representation is easily visible to the user. In addition, because the area of base of the bar is small (the size equivalent to the node), the position of the node in the hierarchical structure can readily be known.

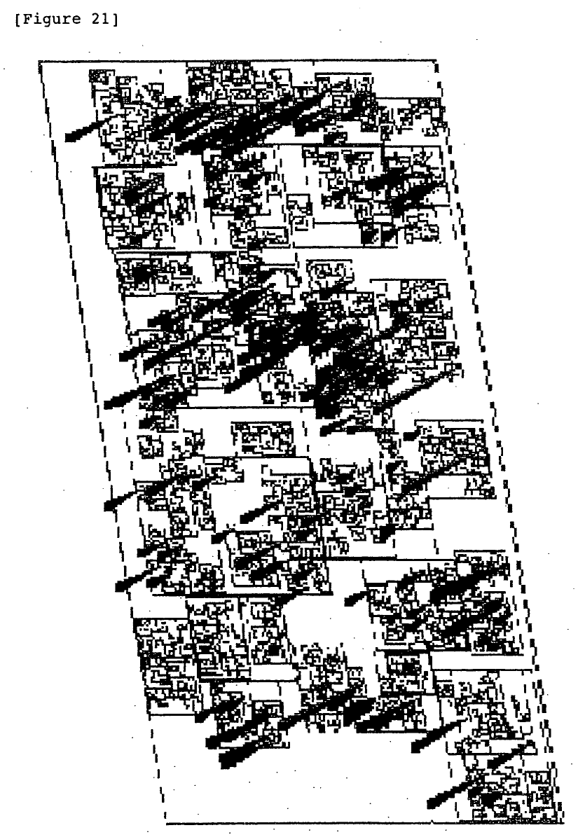

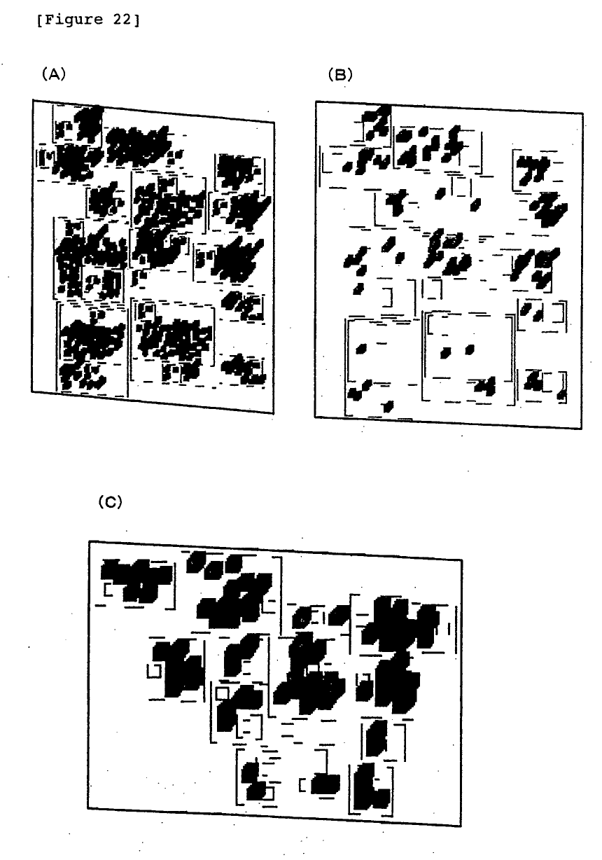

FIG. 21 shows a graphics image provided by reshaping the bar graphs displayed on nodes in the graphics image shown in FIG. 20. Comparing FIGS. 21 and 22, it can be seen that the heights and colors of the bars are made easily visible by representing the bars by quadrangular pyramids. If the graphics image is used to provide a GUI, the operation of mouse-clicking a bar to specify the corresponding node becomes easier.

While a bar graph is represented by a quadrangular pyramid in this example, a circular cone or triangular pyramid (cone) may also be used depending on the cross-section area of an original bar.

Second Approach: Rearranging Nodes:

In the second approach to making bar graphs more visible, nodes to be displayed are rearranged so as to bring them closer to each other, thereby reducing the size of a graphics image (the size of the rectangle corresponding to the root node). Then, the graphics image in which the nodes are rearranged is zoomed in to relatively expand the display size of each node. Because the display size of each node is made large, bar graphs are displayed thicker and thus a representation easily visible to a user is provided.

FIG. 22 shows an example of a graphics image generated from given hierarchical data. FIG. 22 (A) shows a graphics image generated without filtering and FIG. 22 (B) shows a graphics image by performing given filtering. Comparing FIG. 22 (A) and FIG. 22 (B), it can be seen that the number of nodes displayed is reduced in FIG. 22 (B), and consequently attributes of each individual node can easily be examined. However, because the gaps between the nodes are large, there is a large amount of wasted space (containing no information) in the image in FIG. 22 (B). As the size of data becomes larger, the display size of each node becomes smaller (and the bar graph becomes thinner), attributes may become harder to examine. Therefore, the display nodes in FIG. 22 (B) are rearranged to reduce the gaps between them to regenerate a graphics image as shown in FIG. 22 (C), thereby reducing wasted areas on the screen and expanding the display size of each node. Thus, the visibility of color and height of each bar graph is further improved. Furthermore, if the graphics image is used to provide a GUI, the operation of mouse-clicking a bar to specify the corresponding node becomes easier.

For the purpose of examining a generated graphics image, it is important that rearrangement of nodes does not substantially change the relative positions of the nodes. Since a template is used to generate a graphics image in the visualization unit 300 in the present embodiment, a graphics image before rearrangement can be used as a template to generate a graphics image in which nodes are rearranged to satisfy this requirement.

While a generated graphics image is stored in the video memory 13 and then displayed on the displayed on the display unit 14 in the embodiment described above, the graphics image data stored in the video memory 13 can be used also in a CAD (Computer Aided Design) system.

While the visualization unit 300 nests areas representing layers to generate a graphics image representing a hierarchical structure in the present embodiment, the aggregation process and filtering process according to the present embodiment are also effective in generating various other types of graphics images such as Hyperbolic Tree and Treemap images that can represent hierarchical data.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1) A graphics image generation apparatus for visualizing a hierarchical structure of hierarchical data and presenting the visualized data, comprising:
an aggregation unit for performing aggregation of attributes of nodes in said hierarchical data according to given aggregation criteria;
a filtering unit for filtering the result of aggregation performed by said aggregation unit according to given filtering criteria to select nodes to be displayed from said hierarchical data; and
a visualization unit for generating a graphics image that includes said nodes selected by said filtering unit and reflects the hierarchical structure of said hierarchical data.

2) The graphics image generation apparatus according to claim 1, characterized in that said aggregation unit obtains an aggregate value for a given node in said hierarchical data, said aggregate value being the result of aggregation of an attribute of said given node, and obtains a summarized aggregate value by summarizing aggregate values for descendant nodes of said given node into the aggregate value of said given node.

3) The graphics image generation apparatus according to claim 2, characterized in that said filtering unit replaces an aggregate value of a node that is determined as being ineligible to be displayed according to the given filtering criteria with said summarized aggregate value and determines whether or not said node is to be displayed.

4) The graphics image generation apparatus according to claim 3, characterized in that said filtering unit determines, on the basis of the degree of meeting the aggregation criteria in said aggregation unit, the order in which determination is made on nodes in said hierarchical data as to whether the nodes are to be displayed by using said summarized aggregate value.

5) The graphics image generation apparatus according to claim 1, characterized in that said visualization unit generates a graphics image in which a bar graph representing an attribute of a node to be displayed is placed on the node according to the result of aggregation by said aggregation unit after filtering by said filtering unit.

6) The graphics image generation apparatus according to claim 5, characterized in that said visualization unit makes said bar graph placed on said node to be displayed into substantially conical or pyramid form the base of which conforms to the display shape of said node to be displayed and the cross-section area of which gradually increasing toward the top of the bar graph.

7) The graphics image generation apparatus according to claim 1, wherein said visualization unit nests predetermined graphics elements representing said nodes to be displayed to generate a graphics image in which nested layers of the hierarchical structure of said hierarchical data are placed.

8) The graphics image generation apparatus according to claim 7, characterized in that said visualization unit determines placement of said node to be displayed by using a previously generated graphics image as a template to generate a new graphics image.

9) A data analysis apparatus for analyzing a set of data stored in a database, comprising:
an aggregation unit for aggregating, according to given aggregation criteria, attributes of data classified in a give category system having a hierarchical structure;
a filtering unit for filtering said category system according to given filtering criteria by using the result of aggregation by said aggregation unit to select valid categories according to said filtering criteria; and
an analysis result output unit for generating and displaying a graphics image that includes said valid categories selected by said filtering unit and represents attributes of data included in said valid categories with visual elements.

10) The data analysis apparatus according to claim 9, characterized in that:
said aggregation unit obtains an aggregate value for a give category in said category system, said aggregate value being the result of aggregation of an attribute included only in said category, and obtains a summarized aggregate value by summarizing aggregate values of attributes of data included in a lower-level category of said category; and
said filtering unit replaces an aggregate value of a category that is determined as being invalid according to the given filtering criteria with said summarized aggregate value and determines whether or not said category is valid.

11) The data analysis apparatus according to claim 9, characterized in that said visualization unit generates a graphics image in which bar graph representing an attribute of data included in said valid category is placed on the category according to the result of aggregation by said aggregation unit after filtering by said filtering unit.

12) The data analysis apparatus according to claim 9, further comprising an event extraction unit for extracting a given input operation on the visual element of said graphics image displayed by said visualization unit as an event for specifying a category including data corresponding to said visual element,
characterized in that said filtering unit performs filtering according to information indicating the specification of said category that has been extracted by said event extraction unit.

13) A graphics image generation method for visualizing a hierarchical structure of hierarchical data and presenting the visualized data, comprising:
a first step of performing aggregation of attributes of pieces of data in said hierarchical data according to given aggregation criteria and storing the result of said aggregation in given storage means;
a second step of filtering the result of the aggregation according to given filtering criteria to select nodes be displayed from said hierarchical data and storing information about said selected nodes in given storage means; and
a third step of generating a graphics image that includes said nodes selected by said filtering unit and reflects the hierarchical structure of said hierarchical data.

14) The graphics image generation method according to claim 13, characterized in that:
said first step obtains an aggregate value for a given node in said hierarchical data, said aggregate value being the result of aggregation of an attribute of said given node, and obtains a summarized aggregate value by summarizing aggregate values for descendant nodes of said given node into the aggregate value of said given node; and
said second step replaces an aggregate value of a node that is determined as being ineligible to be displayed according to the given filtering criteria with said summarized aggregate value and determines whether or not said node is to be displayed.

15) A data analysis method for analyzing a set of data stored in a database, comprising:
a first step of aggregating, according to given aggregation criteria, attributes of data classified in a give category system having a hierarchical structure and storing the result of the aggregation in give storage means;
a second step of filtering said category system according to given filtering criteria by using the result of the aggregation to select valid categories according to said filtering criteria and storing information about said selected valid categories in given storage means; and
a third step of generating and displaying a graphics image that includes said valid categories and represents attributes of data included in said valid categories with visual elements.

16) The data analysis method according to claim 15, further comprising:
a fourth step of extracting a given input operation on the visual element of said graphics image displayed as an event for specifying a category including data corresponding to said visual element;
a fifth step of performing filtering according to extracted information indicating the specification of said category, selecting valid categories according to said filtering criteria, and storing information about said selected valid categories in given storage means; and
a sixth step of generating and displaying a graphics image that includes said valid categories and represents attributes of data included in said valid categories with visual elements.

17) A program in a graphics image generation apparatus for visualizing a hierarchical structure of hierarchical data and presenting the visualized data, said program causing a computer to function as:
aggregation means for performing aggregation of attributes of pieces of data in said hierarchical data according to given aggregation criteria;
filtering means for filtering the result of aggregation performed by said aggregation means according to given filtering criteria to select nodes to be displayed from said hierarchical data; and
visualization means for generating a graphics image that includes said nodes selected by said filtering means and visualizes the hierarchical structure of said hierarchical data.

18) The program according to claim 17, characterized in that:
said aggregation means obtains an aggregate value for a given node in said hierarchical data, said aggregate value being the result of aggregation of an attribute of said given node, and obtains a summarized aggregate value by summarizing aggregate values for descendant nodes of said given node into the aggregate value of said given node; and
said filtering means replaces an aggregate value of a node that is determined as being ineligible to be displayed according to the given filtering criteria with said summarized aggregate value and determines whether or not said node is to be displayed.

19) The program according to claim 18, characterized in that said filtering means determines, on the basis of the degree of meeting the aggregation criteria in said aggregation means, the order in which determination is made on nodes in said hierarchical data as to whether the nodes are to be displayed by using said summarized aggregate value.

20) A program for causing a computer to function as:
aggregation means for aggregating, according to given aggregation criteria, attributes of data classified in a give category system having a hierarchical structure;
filtering means for filtering said category system according to given filtering criteria by using the result of aggregation by said aggregation means to select valid categories according to said filtering criteria; and
visualization means for generating and displaying a graphics image that includes said valid categories selected by said filtering means and represents attributes of data included in said valid categories with visual elements.

21) The program according to claim 20, further causing said computer to function as event extraction means for extracting a given input operation on the visual element of said graphics image displayed by said visualization means as an event for specifying a category including data corresponding to said visual element,
characterized in that said filtering means performs filtering according to information indicating the specification of said category that has been extracted by said event extraction means.

22) A recording medium on which the program according to claim 17 is recorded in computer-readable form.

23) A computer program product comprising a computer usable medium having computer readable program code means embodied therein for causing visualization of a hierarchical structure of hierarchical data and presenting the visualized data, the computer readable program code means in said computer program product comprising computer readable program code means for causing a computer to effect the functions of claim 1.

24) A computer program product comprising a computer usable medium having computer readable program code means embodied therein for causing analysis of a set of data stored in a database, the computer readable program code means in said computer program product comprising computer readable program code means for causing a computer to effect the functions of claim 9.

25) An article of manufacture comprising a computer usable medium having computer readable program code means embodied therein for causing visualization of a hierarchical structure of hierarchical data and presenting the visualized data, the computer readable program code means in said article of manufacture comprising computer readable program code means for causing a computer to effect the steps of claim 13.

26) An article of manufacture comprising a computer usable medium having computer readable program code means embodied therein for causing analysis of a set of data stored in a database, the computer readable program code means in said article of manufacture comprising computer readable program code means for causing a computer to effect the steps of claim 15.

27) A program storage device readable by machine, tangibly embodying a program of instructions executable by the machine to perform method steps for visualizing a hierarchical structure of hierarchical data and presenting the visualized data, said method steps comprising the steps of claim 13.

28) A program storage device readable by machine, tangibly embodying a program of instructions executable by the machine to perform method steps for analyzing a set of data stored in a database, said method steps comprising the steps of claim 15.
